(19) United States
(12) Patent Application Publication
(10) Pub. No.: US 2019/0286798 A1
(43) Pub. Date: Sep. 19, 2019

(54) USER AUTHENTICATION METHOD USING FACE RECOGNITION AND DEVICE THEREFOR

(71) Applicant: Yong Sang KIM, Busan (KR)

(72) Inventor: Yong Sang KIM, Busan (KR)

(21) Appl. No.: 16/317,647

(22) PCT Filed: Jul. 14, 2017
(86) PCT No.: PCT/KR2017/007575

§ 371 Date: Jan. 14, 2019

(30) Foreign Application Priority Data
Jul. 14, 2016 (KR) 10-2016-0089201

(51) Int. Cl. G06F 21/32; G06K 9/00

(52) U.S. Cl. CPC G06F 21/32; G06K 9/00248; G06K 9/00288; G06K 9/00281

(57) ABSTRACT

Provided is a user authentication method using face recognition and a device therefor. The user authentication method in a user authentication device includes capturing a face image of a user by using a camera module, identifying a plurality of figures based on positions of an eye, a nose, a mouth or an ear of the face image, and approving user identity based on the plurality of figures.

### TECHNICAL FIELD

The present disclosure relates to a user authentication method and a device therefor, and more particularly to, a method of authenticating a user by using a face captured by a camera, and a device therefor.

### BACKGROUND ART

User authentication has been widely used in various fields such as finance, online shopping, and payment. However, while most authentication methods are password input methods, some methods use biometric information such as fingerprints or irises.

In the password-based authentication method, a risk that a password may be exposed to others exists, and a user has to remember the password at all times. An authentication method using biometric information such as a fingerprint or an iris is advantageous in that the user does not need to memorize additional information and the biometric information is not exposed to others, but a complicated algorithm for analyzing a fingerprint or iris is required.

### DESCRIPTION OF EMBODIMENTS

### Technical Problem

Provided are a method of authenticating a user through face recognition and a device therefor.

### Solution to Problem

According to an aspect of the present disclosure, a user authentication method in a user authentication device includes capturing a face image of a user by using a camera module, identifying a plurality of figures based on positions of an eye, a nose, a mouth or an ear of the face image, and approving user identity based on the plurality of figures.

### Advantageous Effects of Disclosure

According to the present disclosure, a user can be easily authenticated by photographing a user's face using a user terminal equipped with a camera function, such as a smart phone. The present disclosure can replace a conventional user authentication process required for financial services and various online services in a smartphone, thereby simplifying a complex authentication process and enabling quick authentication. Furthermore, since the authentication process can be substituted with a quantified value of facial features per user, it can be used even in situations where a face hurts or face recognition is not easy. Furthermore, fake authentication using pictures, not by a real person, may be prevented through user authentication using the order and features of facial expression changes. Furthermore, criminals or terrorists can be quickly identified from photos of the criminals or terrorists through the present disclosure.

### BRIEF DESCRIPTION OF DRAWINGS

FIG. 1 illustrates a schematic structure of a user authentication method according to the present disclosure.

FIG. 2 illustrates a configuration of a user authentication device according to an embodiment of the present disclosure.

FIG. 3 illustrates an example of a guide line provided for capturing a face image for user authentication, according to the present disclosure.

FIG. 4 illustrates an example of feature points to identify figures from a face image for user authentication, according to the present disclosure.

FIGS. 5 to 12 illustrate an example of a figure identified from a face image for user authentication, according to the present disclosure.

FIGS. 13 and 14 illustrate an example of a method of identifying user identity based on the figure of FIG. 12.

FIGS. 15 and 16 illustrate an example of a method of identifying user identity based on the figure of FIG. 11.

FIG. 17 illustrates an example of a method of generating a password from a face figure for user authentication, according to the present disclosure.

FIG. 18 is a flowchart of a user authentication method according to an embodiment of the present disclosure.

FIG. 19 is a flowchart of a user authentication method according to another embodiment of the present disclosure.

FIG. 20 illustrates an example of a method of updating a guide line during capturing a face for user authentication, according to the present disclosure.

FIG. 21 illustrates a plurality of face figures superimposed for user authentication, according to the present disclosure.

### MODE OF DISCLOSURE

A user authentication method and a device therefor according to the present disclosure are described in detail below with reference to the accompanying drawings.

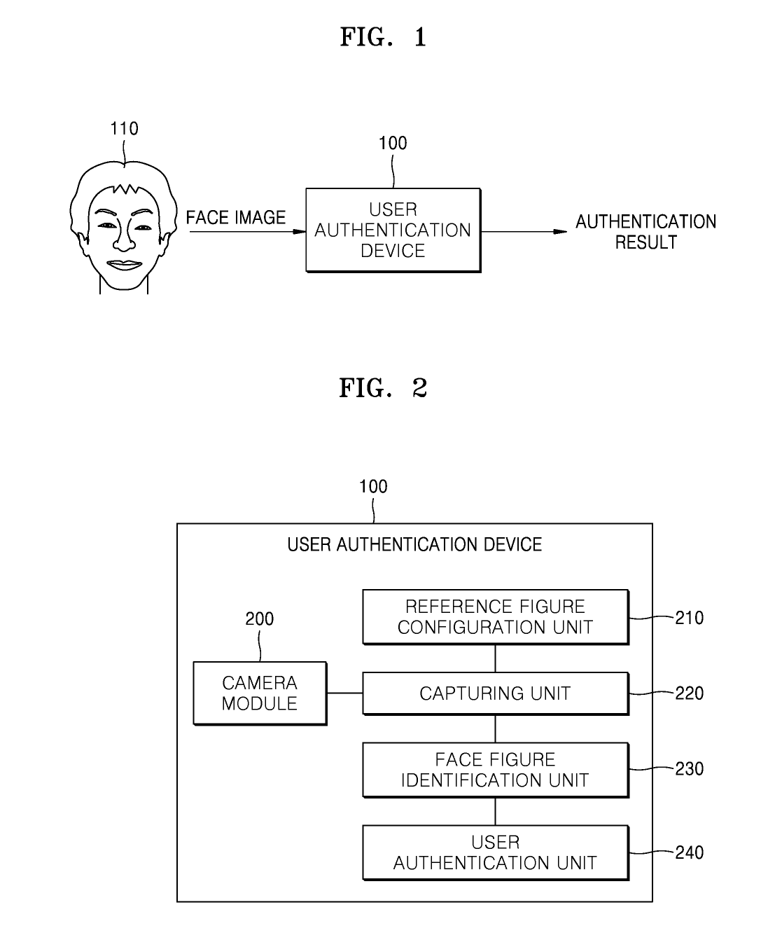

FIG. 1 illustrates a schematic structure of a user authentication method according to the present disclosure.

Referring to FIG. 1, a user authentication device 100 captures an image of a face 110 of a human through a camera module, compares whether a captured face image is identical to a previously stored face image, and outputs a result of the comparison.

It is difficult to identify whether the previously stored face image and the captured face image are identical to each other by simply comparing the previously stored face image with the captured face image. For example, various photographing conditions such as a photographing angle or a photographing distance when capturing a face image are not exactly the same for each time, and accordingly, to identify whether two face images are of the same person, a very complicated process such as converting a plane image to a 3D image and analyzing and comparing each feature point of the 3D image is performed.

Accordingly, the present disclosure provides a method that enables accurate and quick identification of a user's face without a complicated algorithm such as converting a face image to a 3D image.

In the present embodiment, the user authentication device 100 may be implemented in a device equipped with a camera module such as a smartphone, a tablet PC, or a general computer internally or externally.

FIG. 2 illustrates a configuration of the user authentication device 100 according to an embodiment of the present disclosure.

Referring to FIG. 2, the user authentication device 100 may include a camera module 200, a reference figure configuration unit 210, a capturing unit 220, a face figure identification unit 230, and a user authentication unit 240.

The camera module 200 may be implemented by various imaging devices such as a charge-coupled device (CCD) capable of capturing a still image or a motion picture of a user's face. The camera module 200 may be omitted from the user authentication device 100. The user authentication device 100 may include only an interface capable of mounting the camera module 200. The camera module 200 may be implemented in an external type.

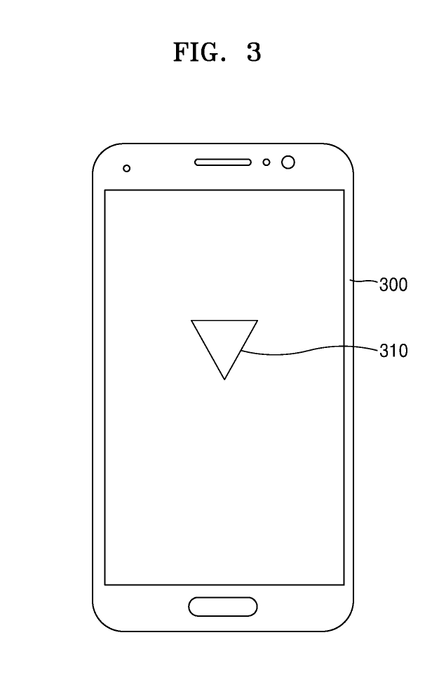

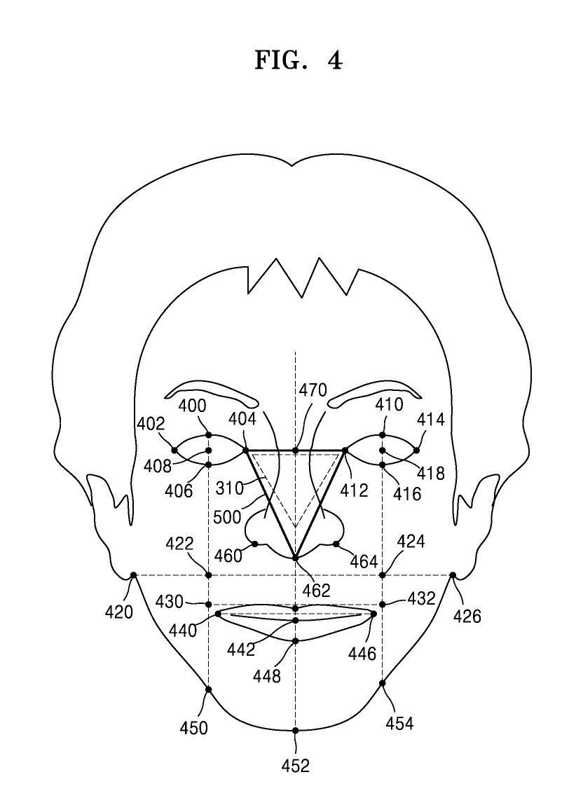

The capturing unit 220 obtains a face image by controlling the camera module 200. Whenever a face image is captured, a photographing distance or a photographing angle between the camera module 200 and a user's face may vary. Accordingly, to make the photographing angle and the photographing distance constant for each time to capture a face image for user authentication, a guide line for capturing a face image may be provided. For example, when the user authentication device 100 is implemented in a user terminal such as a smartphone as illustrated in FIG. 3, a user captures an image of a face by matching the face to a guide line 310 having a triangular shape displayed on a screen of a smartphone 300. The guide line 310 may be adjusted to be matched with a user's face, which is described in FIGS. 3 and 4.

The reference figure configuration unit 210 identifies and stores a reference figure with respect to a user's face for user authentication. In detail, the capturing unit 220 obtains a face image through the camera module 200, and the reference figure configuration unit 210 identifies a plurality of figures based on the respective positions of an eye, a nose, a mouth, and an ear of the face image and stores the identified figures as a reference figure for user authentication. The reference figure for user authentication set by the reference figure configuration unit 210 may be protected by conventional various security algorithms not to be deformed or erased by a third party.

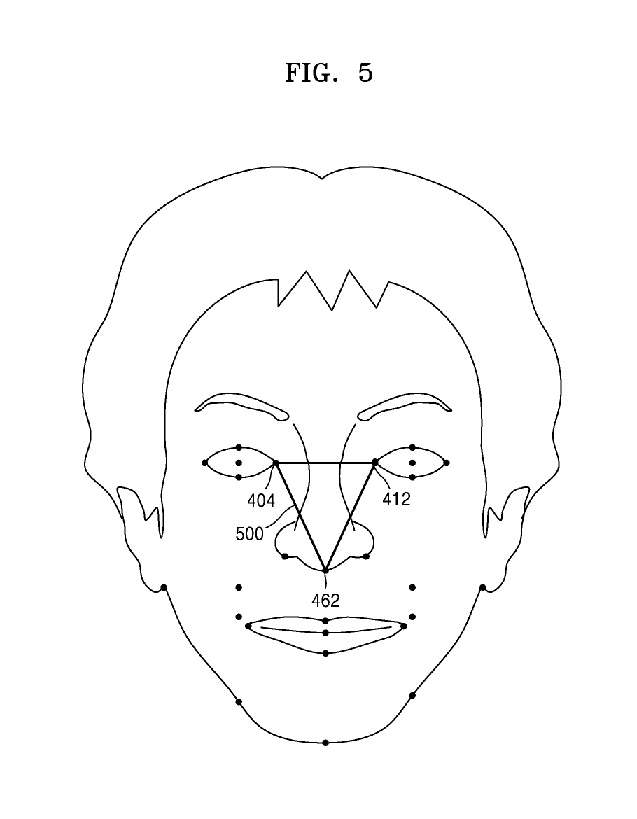

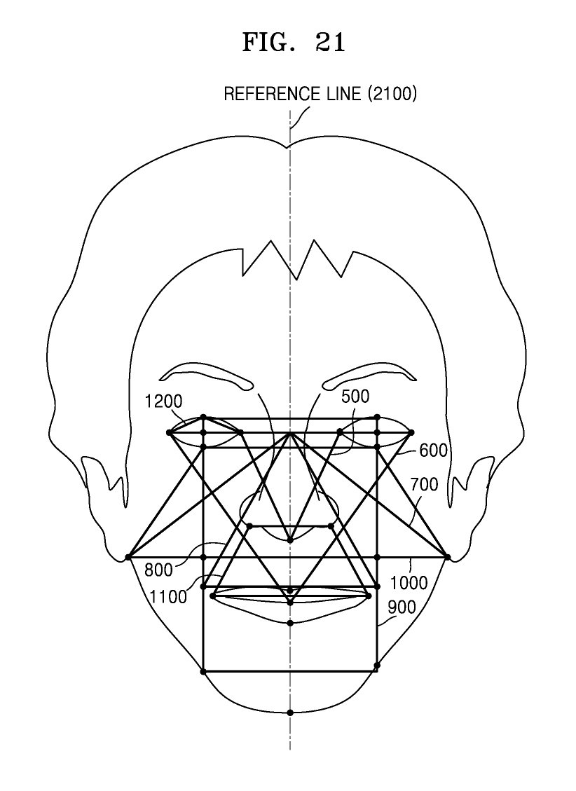

The reference figure for user authentication may include a polygon, such as a triangle or a rectangle, formed by connecting various positions for specifying an eye, a nose, a mouth, and an ear of a face. The reference figure for user authentication may include a plurality of different figures as illustrated in FIGS. 5 to 12. For example, the reference figure may include a plurality of figures as illustrated in FIG. 21.

The reference figure configuration unit 210 may store various reference figures with respect to a user's face. For example, the reference figure configuration unit 210 may identify and store reference figures of various face shapes such as a first reference figure identified from a normal face image, a second reference figure identified from a wry face image, a third reference figure identified from a laughing face image, and a fourth reference figure identified from a one-eye closed face image. Accordingly, the user may perform an authentication process with one's own facial expression or by making facial expressions in a preset order.

The face figure identification unit 230 identifies a preset type of a figure from a face image of a user captured through the camera module. For example, when the reference figure for user authentication is configured as illustrated in FIGS. 5 to 12, the face figure identification unit 230 identifies the face figures of FIGS. 5 to 12 from a currently captured face image. In the following description, to be distinguished from the reference figure for user authentication identified and stored by the reference figure configuration unit 210, a figure identified from the face image by the face figure identification unit 230 is referred to as a face figure.

The user authentication unit 240 compares the face figure identified from the captured face image with the previously stored reference figure for user authentication and authenticates user identity. Even when the photographing angle and the photographing distance of a face image are matched by using the guide line of FIG. 3, the face image may not be completely the same as the previously captured face image. Accordingly, the user authentication unit 240 may authenticate the user identity by considering a figure ratio relation, not by simply comparing figures.

For example, in the case of an inverted triangle 500 of FIG. 5, the size of the reference figure may be greater than or smaller than the face figure. In this case, when the reference figure and the face figure are inverted triangles of the same ratio, the user authentication unit 240 identifies that the reference figure is identical to the face figure. In the same method, the user authentication unit 240 identifies whether each face figure of FIGS. 5 to 12 is identical to the reference figure.

Since the reference figure and the face figure may not be 100% matched with each other, the user authentication unit 240 may set an allowable error range and determine that both are identical to each other when the ratio error is within the allowable error range. For example, the user authentication unit 240 may identify a ratio relation of the reference figure and the face figure, normalize the two figures in a certain size, and identify that both figures are identical to each other when a match ratio of the normalized two figures is 95% or more.

In another embodiment, the user authentication unit 240 may identify the identity based on a quantified value such as a length, a height, a size, or an angle of a figure, not by comparing the figures. For example, the user authentication unit 240 may normalize the reference figure and the face figure in a certain size, identify the value of the length, the height, the size, or the angle, and determine whether the values are within an allowable error range.

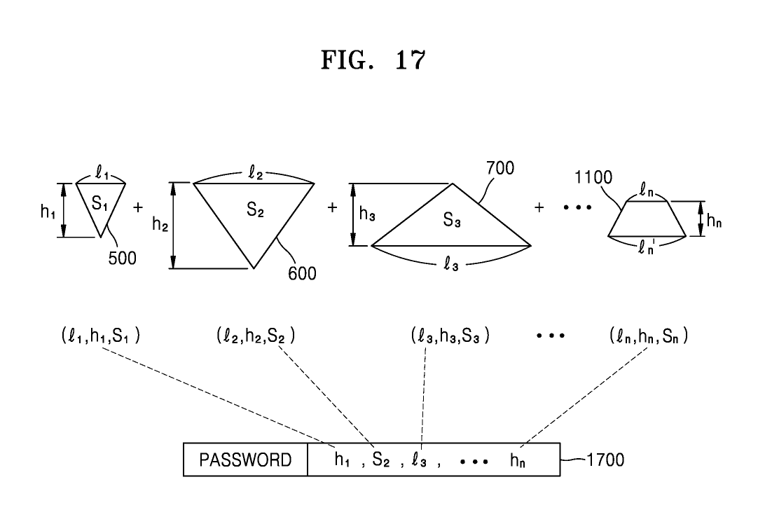

In another embodiment, the user authentication unit 240 may generate and store a password of a certain length including numbers, characters, and special symbols by using quantified values of reference figures, and perform authentication by receiving the password from the user. The authentication using a password may be useful when the user is unable to perform face recognition due to an accident. This is described in detail below with reference to FIG. 17.

In another embodiment, the user authentication unit 240 may receive a plurality of facial expressions from the user and determine user identity based on whether the order of the facial expressions is matched. When the reference figure configuration unit 210 identifies a reference figure with respect to a plurality of facial expressions and stores the reference figure with information about the order of the facial expressions, the user authentication unit 240 may determine user identity based on whether the face figure with respect to the facial expressions identified by the face figure identification unit 230 matches the reference figure with respect to each of the facial expressions.

FIG. 3 illustrates an example of a guide line provided for capturing a face image for user authentication, according to the present disclosure.

Referring to FIG. 3, the guide line 310 is not limited to the inverted triangle and may have various shapes such as a rectangle, a pentagon, or a circle, or a shape of an eye, a nose, a mouth, or a combination thereof, which may be variously modified according to embodiments.

When a face image is captured to generate a reference figure for user authentication, the guide line 310 is displayed on the screen as illustrated in FIG. 3. The user matches the respective corners of the inverted triangle 310 to two inner points 404 and 412 of the eyes and a lower point 462 of a nose, as illustrated in FIG. 4, and then captures the face image. However, since the shape of a face is different from user to user, the respective corners of the triangle 310 may not accurately match the two inner points 404 and 412 of the eyes and the lower point 462 of the nose. In this case, the user captures a face by approximately matching the face to the guide line 310.

When the user authentication device 100 captures a face image to generate a reference figure for user authentication, the captured face image is analyzed to generate reference figures as illustrated in FIGS. 5 to 12. In this state, the guide line 310 of FIG. 3 may be adjusted to match the user's face based on the identified reference figures.

For example, as illustrated in FIG. 4, when the inverted triangle that is the initial guide line 310 does not match the user's face, the user authentication device 100 updates the inverted triangle 500 identified through FIG. 5 with a new guide line. Accordingly, thereafter, when the user captures an image for authentication, the guide line displayed on the screen may be the inverted triangle 500 of FIG. 4, not the inverted the triangle 310 of FIG. 3. When generating a reference figure by using the updated guide line 500, the user may capture a face image in a state of being matched with the captured photographing angle or photographing distance.

FIG. 4 illustrates an example of feature points to identify figures from a face image for user authentication, according to the present disclosure.

Referring to FIG. 4, the user authentication device 100 provides the guide line 500 adjusted for each user and captures a user's face matched with the guide line. The user authentication device 100 may notify matching through a color change of the guide line or sound to allow the user to easily recognize that the user's face matches the guide line.

For example, the user authentication device 100 displays the guide line of the inverted triangle 500 first in white, and when the respective corners of the inverted triangle 500 are matched with the two inner points 404 and 412 of the eyes and the lower point 462 of the nose, change the color of the guide line to, for example, green. In some embodiments, the user authentication device 100 may enable face capturing only when the face is matched with the guide line.

When the face image is captured, the user authentication device 100 identifies various face figures of FIGS. 5 to 12 based on feature points 400 to 464 of the face image. Since there are various conventional face analysis algorithms for detecting various positions of an eye, a nose, a mouth, and an ear from the face image, a description of a method of detecting the respective positions of a face in the present embodiment is omitted.

However, according to the present embodiment, some characteristic figures are identified to well detect features for each user, and examples of the figures are discussed with reference to FIGS. 5 to 12.

FIGS. 5 to 12 illustrate an example of a figure identified from a face image for user authentication, according to the present disclosure.

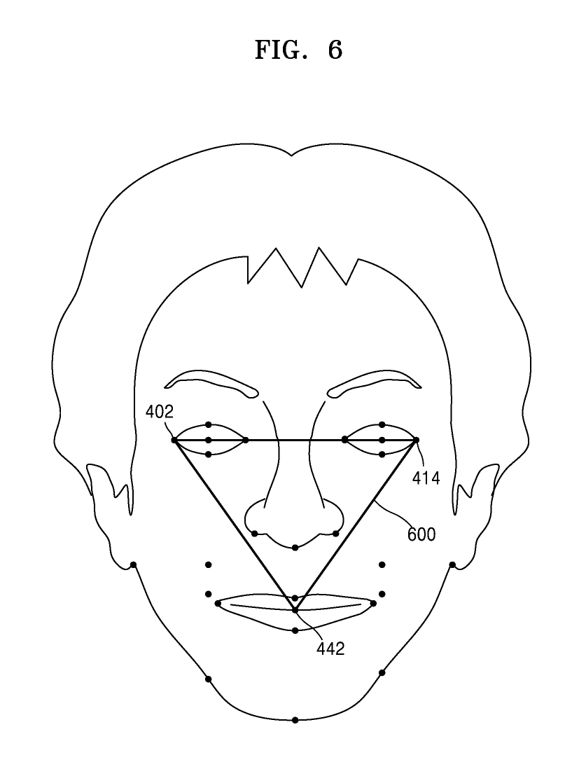

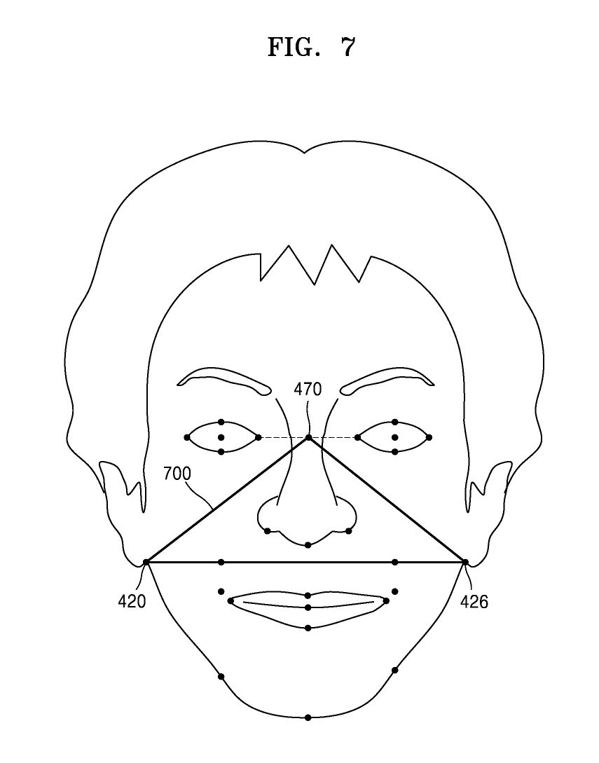

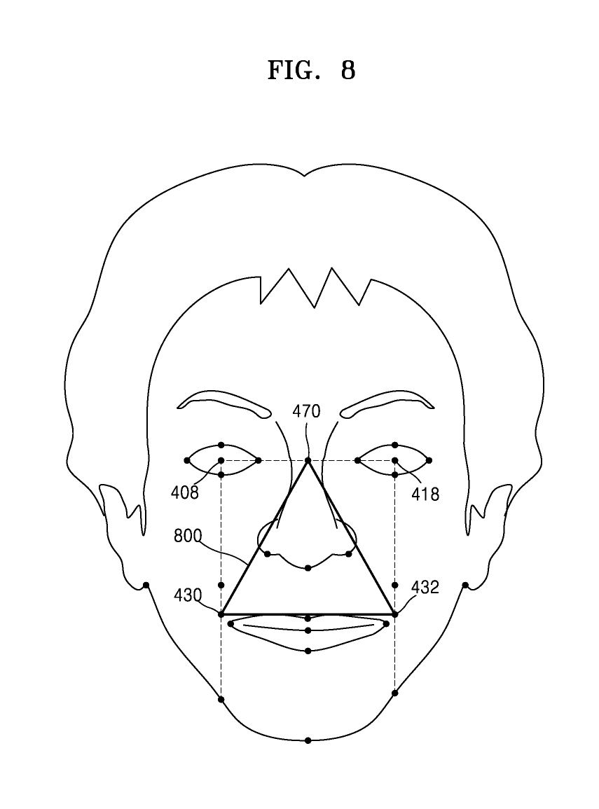

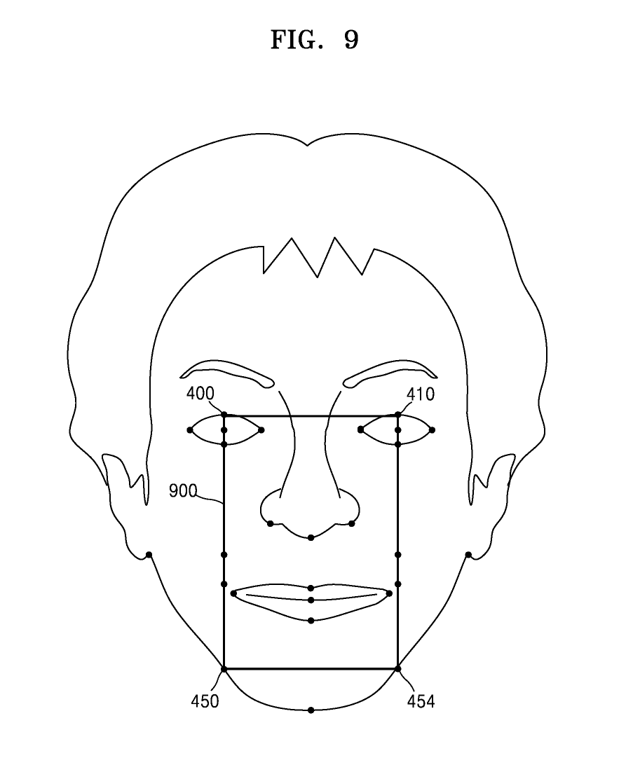

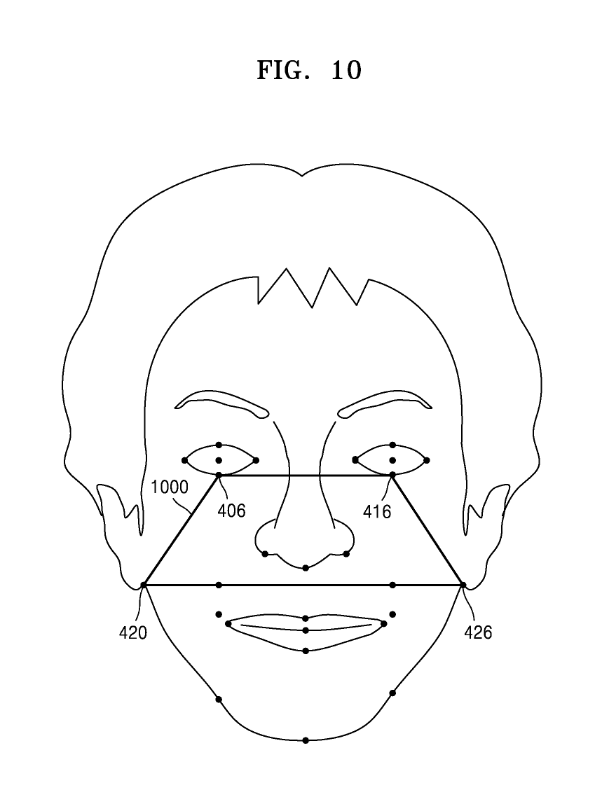

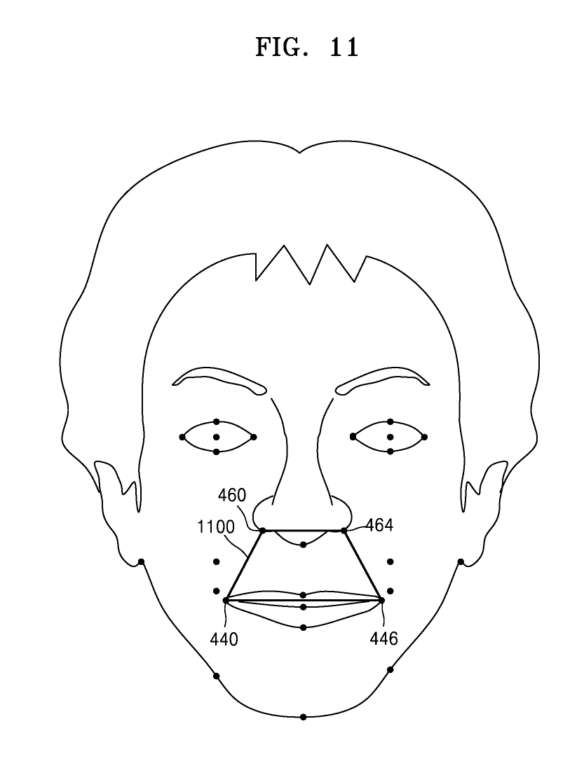

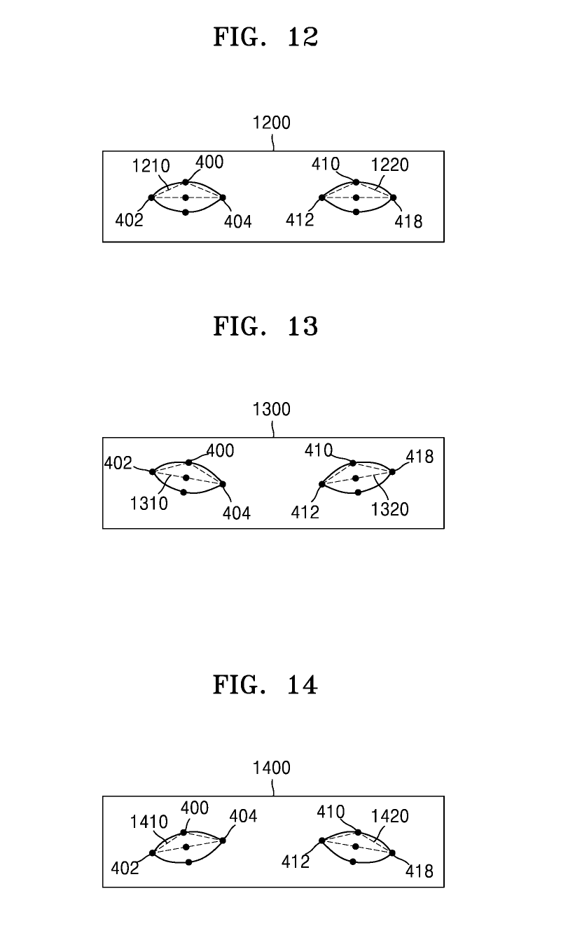

Referring to FIGS. 5 to 12, the user authentication device 100 identifies the inverted triangle 500 of FIG. 5 connecting the inner points 404 and 412 of the eyes and the lower point 462 of the nose, an inverted triangle 600 of FIG. 6 connecting outer points 402 and 414 of the eyes and a middle point 442 of the mouth, a triangle 700 of FIG. 7 connecting a center point 470 between the eyes and lower points 420 and 426 of the ears, a triangle 800 of FIG. 8 connecting two points 430 and 432 where straight vertical lines extending downward from centers 408 and 418 of the eyes meet a horizontal line contacting an upper part of the mouth, and the center point 470 between the eyes, a rectangle 900 of FIG. 9 connecting points 450 and 454 where straight vertical lines extending downward from the centers 408 and 418 of the eyes meet an outline of a face, and two upper points 400 and 410 of the eyes, a trapezoid 1000 of FIG. 10 connecting lower points 406 and 416 of the eyes and the lower points 420 and 426 of the ears, a trapezoid 1100 of FIG. 11 connecting both end points 460 and 464 of the nose and both end points 440 and 446 of the mouth, and triangles 1210 and 1220 of FIG. 12 connecting the outer points 402, 404, 412, and 418 of the eyes and the upper points 400 and 410 of the eyes.

Since the length of a face, the length of a nose, the length between eyes, the length of a philtrum, the size of a mouth, and the positions of ears are different from user to user, all face figures of FIGS. 5 to 12 are hardly matched between users. For more accuracy, any figure other than the face figures of FIGS. 5 to 12 may be additionally used.

FIGS. 5 to 12 illustrate examples to help understanding of the present disclosure, and the present disclosure is not limited thereto. In some embodiments, various figures may be used.

FIGS. 13 and 14 illustrate an example of a method of identifying user identity based on the figure of FIG. 12.

The triangles 1310 and 1320 of FIG. 13 are inclined inward, and the triangles 1410 and 1420 of FIG. 14 are inclined outward. When the triangle FIGS. 1210 and 1220 of the eyes of FIG. 12 are reference figures for user authentication, whether inclinations of the respective triangles 1310, 3120, 1410, and 1420 of FIGS. 13 and 14 are identical to the inclinations of the triangles 1210 and 1220 of FIG. 12 is checked.

Furthermore, since the size of a triangle in an eye may vary according to the size of each user's eye, the sizes of the triangles 1210 and 1220 of FIG. 12 that are the reference figures are compared with the sizes of the triangles 1310 and 1320 of FIGS. 13 and 14 to determine identity therebetween.

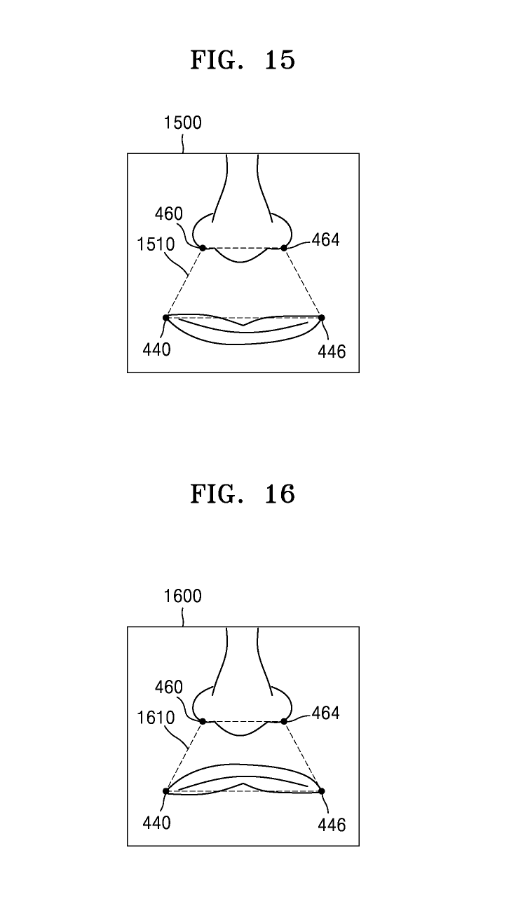

FIGS. 15 and 16 illustrate an example of a method of identifying user identity based on the figure of FIG. 11.

In a user's face of FIG. 15, the corners of a mouth is pulled up, and in a user's face of FIG. 16, the corners of a mouth is depressed. The height, length, or size of a trapezoid may vary according to the positions of the mouth corners. When FIG. 11 illustrates a reference figure for user authentication (1100), the height, length, or size of the trapezoid 1100 of FIG. 11 is compared with the height, length, or size of each of the trapezoids 1510 and 1610 of FIGS. 15 and 16, thereby identifying the user identity.

FIG. 17 illustrates an example of a method of generating a password from a face figure for user authentication, according to the present disclosure.

Referring to FIG. 17, the user authentication device 100 identifies values of the heights, lengths, or sizes of the face figures of FIGS. 5 to 12 and generates a password by combining all or some of the values and stores the password.

The user authentication device 100 may make the values identified from the respective figures into a value of a specific length by using various operations or functions. For example, the user authentication device 100 may generate a value of a specific length by using a hash function having the height, length, or size of the respective figures as input values and use the value of a specific length as a password.

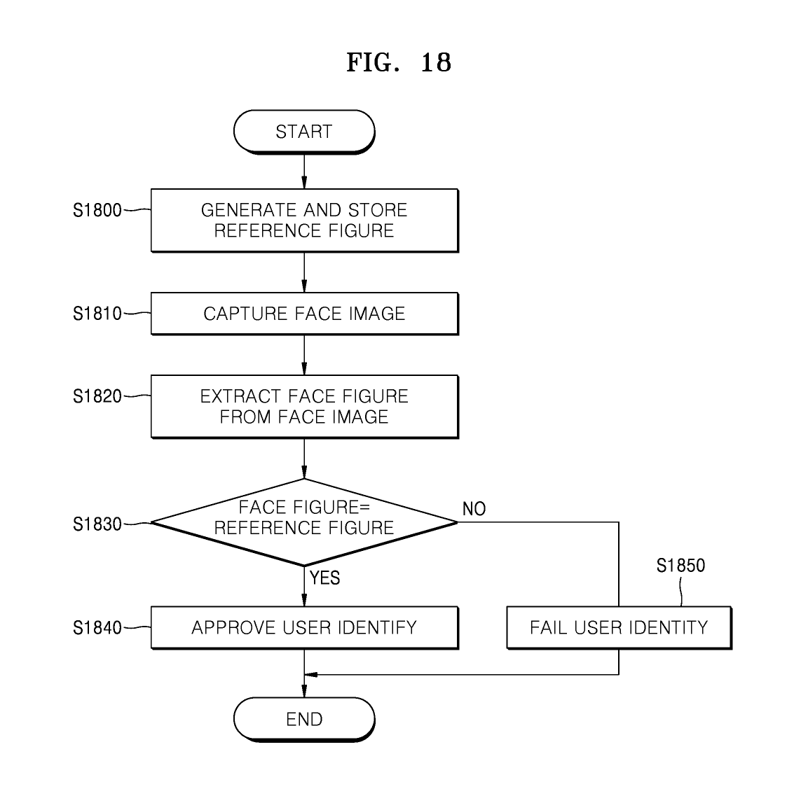

FIG. 18 is a flowchart of a user authentication method according to an embodiment of the present disclosure.

Referring to FIG. 18, the user authentication device 100 captures a face image and generates and stores a reference figure for user authentication (S1800). In this state, in order to more accurately capture a user's face image, a guide line as illustrated in FIG. 3 is provided on a screen. The user matches a face to the guide line displayed on the screen and captures a face image.

When user authentication is needed, the user authentication device 100 captures a face image (S1810) and extracts a face figure from a captured face image (S1820). In this state, the user authentication device 100 provides a guide line updated based on information identified during generating of a reference figure, not providing the same guide line as before.

When the reference figure and the face figure are compared and found to be identical to each other (S1830), user identify is verified (S1840). When the reference figure and the face figure do not match with each other, user identify is not verified (S1850).

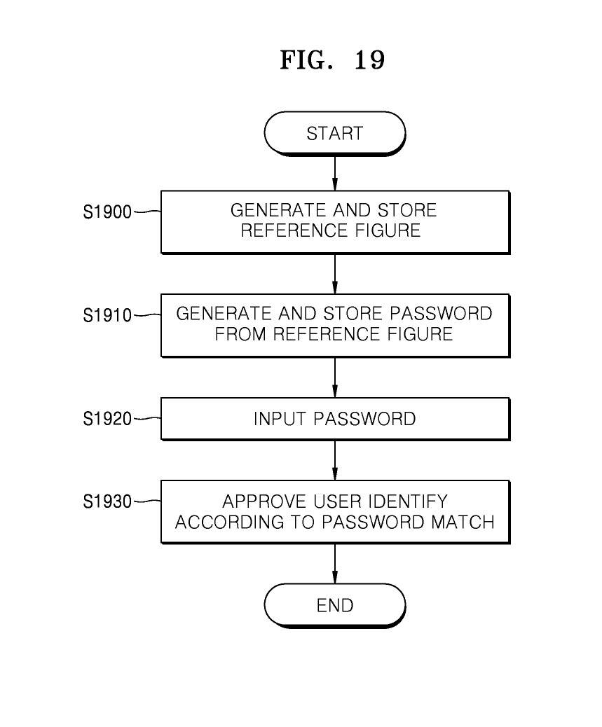

FIG. 19 is a flowchart of a user authentication method according to another embodiment of the present disclosure.

Referring to FIG. 19, the user authentication device 100 captures a face image and generates and stores a reference figure for user authentication (S1900). In this state, in order to more accurately capture a user's face image, a guide line as illustrated in FIG. 3 is provided on the screen. The user matches the face to the guide line displayed on the screen and captures the face image. Furthermore, the user authentication device 100 generates and stores a password by using quantified information such as the length, height, or size of a reference figure as illustrated in FIG. 17 (S1910).

The user inputs the password for authentication, not by capturing a face, unlike FIG. 18 (S1920). The user authentication device 100 verifies user identity based on whether the password input by the user and a previously stored password are matched with each other (S1930).

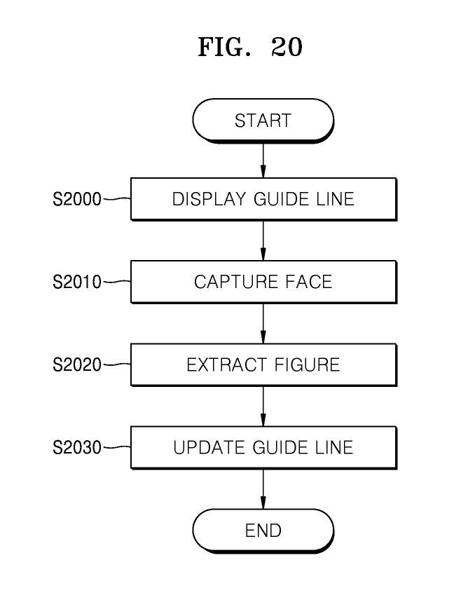

FIG. 20 illustrates an example of a method of updating a guide line during capturing a face for user authentication, according to the present disclosure.

Referring to FIG. 20, the user authentication device 100 displays a guide line for capturing a face image on the screen (S2000). When the user captures a face image to fit to the guide line (S2010), the user authentication device 100 identifies a reference figure by analyzing the face image (S2020). The user authentication device 100 updates the guide line according to the reference figure (S2030).

FIG. 21 illustrates a plurality of face figures superimposed for user authentication, according to the present disclosure.

Referring to FIG. 21, the user authentication device 100 captures a user's face, and when a plurality of face figures identified from the user match a reference figure, user identity is approved.

The heights of a plurality of face figures may be identified based on a reference line 2100 passing through the middle of the face. Accordingly, the user identity may be approved based on the height ratio of each figure identified based on the reference line 2100 and the height ratio of the reference figure. Furthermore, when the face is inclined vertically or horizontally, the identity with the reference figure may be easily identified by normalizing a plurality of face figures based on the reference line 2100.

In another example, the user authentication device 100 may be implemented by a device such as a server and stores reference figures for a plurality of users, and receives and compares face images captured through an external CCTV or a camera of a user terminal, thereby identifying user identity. Accordingly, criminals or missing persons may be identified in real time.

The disclosure can also be embodied as computer-readable code on a computer-readable recording medium. The computer-readable recording medium is any data storage device that can store data which can thereafter be read by a computer system. Examples of the computer-readable recording medium include read-only memory (ROM), random-access memory (RAM), CD-ROMs, magnetic tapes, floppy disks, optical data storage devices, etc. The computer-readable recording medium can also be distributed over network-coupled computer systems so that the computer-readable code is stored and executed in a distributive manner.

While this disclosure has been particularly shown and described with reference to embodiments thereof, it will be understood by those skilled in the art that various changes in form and details may be made therein without departing from the spirit and scope of the disclosure as defined by the appended claims. The embodiments should be considered in descriptive sense only and not for purposes of limitation. Therefore, the scope of the disclosure is defined not by the detailed description of the disclosure but by the appended claims, and all differences within the scope will be construed as being included in the present disclosure.

1. A user authentication method in a user authentication device, the method comprising:
capturing a face image of a user by using a camera module;
identifying a plurality of figures based on positions of an eye, a nose, a mouth or an ear of the face image; and
approving user identity based on the plurality of figures.

2. The user authentication method of claim 1, wherein the capturing of the face image of the user comprises:
displaying the face image of the user and a reference figure on a screen; and
capturing the face image when a figure extracted from the face image of the user matches the reference figure.

3. The user authentication method of claim 2, wherein the displaying of the face image of the user and a reference figure comprises indicating that the figure extracted from the face image matches the reference figure, through a color of the reference figure or sound, when the figure extracted from the face image matches the reference figure.

4. The user authentication method of claim 1, further comprising registering a reference figure, before capturing of the face image of the user,
wherein the registering of the reference figure comprises:
extracting a figure from the face image; and
storing the extracted figure as the reference figure.

5. The user authentication method of claim 1, wherein the identifying of the plurality of figures comprises:
identifying a first figure formed by connecting the eyes and a nose of a face;
identifying a second figure formed by connecting the eyes and a mouth of the face;
identifying a third figure formed by connecting a center between the eyes and ears of the face;
identifying a fourth figure formed by connecting points where vertical lines extending downward from the eyes meet an outline of the face;
identifying a fifth figure formed by connecting points where the center between the eyes and a horizontal line of the mouth of the face meet the vertical lines of the fourth figure; and
identifying a sixth figure formed by connecting the eyes and the ears of the face.

6. The user authentication method of claim 1, wherein the approving of the user identity comprises:
calculating a horizontal length, a height, or a size of each of the plurality of figures; and
identifying identity based on the length, height or size.

7. A non-transitory computer-readable recording medium having stored thereon a program, which when executed by a computer, performs the method defined in claim 1.
